(19) United States
(12) Patent Application Publication
(10) Pub. No.: US 2024/0056941 A1
(43) Pub. Date: Feb. 15, 2024

(54) APPARATUS AND METHOD FOR ROUTING IN SIDELINK RELAY NETWORKS

(71) Applicant: SAMSUNG ELECTRONICS CO., LTD., Suwon-si (KR)

(72) Inventors: Milos TESANOVIC, Staines (GB); Hyunjeong KANG, Suwon-si (KR)

(21) Appl. No.: 18/446,343

(22) Filed: Aug. 8, 2023

(30) Foreign Application Priority Data
Aug. 10, 2022 (GB) 2211706.3

(51) Int. Cl. H04W 40/22; H04W 40/12

(52) U.S. Cl. CPC H04W 40/22; H04W 40/12

(57) ABSTRACT

The disclosure relates to a 5G or 6G communication system for supporting a higher data transmission rate. A routing method in a wireless communication system comprising a network, a destination remote user equipment (UE), and at least one intermediate UE, the method comprising: selecting at least one path of a plurality of paths for communicating data between the network and destination remote UE; wherein at least one of the plurality of paths is an indirect path that includes the at least one intermediate UE; and wherein the at least one intermediate UE comprises at least one of a further remote UE and a relay UE.

### CROSS-REFERENCE TO RELATED APPLICATIONS

This application is based on and claims priority under 35 U.S.C. § 119 to United Kingdom Patent Application No. 2211706.3 filed on Aug. 10, 2022, in the United Intellectual Property Office, the disclosure of which is incorporated by reference herein in its entirety.

### BACKGROUND

### 1. Field

Certain examples of the present disclosure provide various techniques relating to routing in sidelink relay networks, in particular in a network incorporating sidelink relay adaptation protocol (SRAP), for example within 3rd generation partnership project (3GPP) 5th generation (5G) new radio (NR) and NR-based relay networks.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In 3rd generation partnership project (3GPP) 5th generation (5G) new radio (NR), sidelink relay adaptation protocol (SRAP) is intended to allow the functioning of UE-to-network (U2N) and UE-to-UE (U2U) sidelink relaying networks. For example, in the U2N case, a signal may be transmitted from a base station to a destination UE via a relay UE which has a sidelink (PC5) connection to the destination remote UE, and the SRAP layer is used on both the Uu link (between the base station and the relay UE), and the PC5 link (between the relay UE and the remote UE). The main functionality of SRAP is mapping of uplink (UL) PC5 bearers onto Uu bearers, and performing the inverse process on the downlink (DL). It is also used to identify nodes in the relaying network.

Work on Release 17 of 3GPP 5G is currently underway. An aim of Release 17 is to develop and improve features relating to SRAP.

The above information is presented as background information only to assist with an understanding of the present disclosure. No determination has been made, and no assertion is made, as to whether any of the above might be applicable as prior art with regard to the present disclosure.

### SUMMARY

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present disclosure is defined in the independent claims. Advantageous features are defined in the dependent claims.

Embodiments or examples disclosed in the description and/or figures falling outside the scope of the claims are to be understood as examples useful for understanding the present disclosure.

Other aspects, advantages, and salient features of the disclosure will become apparent to those skilled in the art from the following detailed description taken in conjunction with the accompanying drawings.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example user plane protocol stack for L2 UE-to-NW relay according to an embodiment of the present disclosure;

FIG. 2 illustrates an example control plane protocol stack for L2 UE-to-NW relay according to an embodiment of the present disclosure;

FIG. 3 illustrates steps in routing method in a network comprising a gNB, a remote UE, and a relay UE according to an embodiment of the present disclosure;

FIG. 4 illustrates steps in routing method in a system comprising source and target gNBs, a remote UE, and a relay UE according to an embodiment of the present disclosure;

FIG. 5 illustrates steps in routing method in a system comprising source and target gNBs, a remote UE, and a relay UE according to an embodiment of the present disclosure;

FIG. 6 illustrates an exemplary network entity according to an embodiment of the present disclosure;

FIG. 7 illustrates a structure of a UE according to an embodiment of the present disclosure; and

FIG. 8 illustrates a structure of a base station according to an embodiment of the present disclosure.

### DETAILED DESCRIPTION

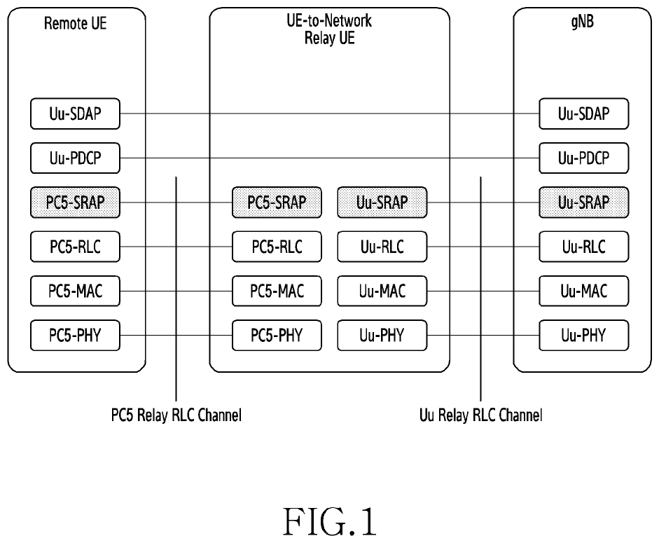

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description of examples of the present disclosure, with reference to the accompanying drawings, is provided to assist in a comprehensive understanding of the present disclosure, as defined by the claims. The description includes various specific details to assist in that understanding but these are to be regarded as merely exemplary. Accordingly, those of ordinary skill in the art will recognize that various changes and modifications of the examples described herein can be made.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present disclosure.

The terms and words used herein are not limited to the bibliographical or standard meanings, but are merely used to enable a clear and consistent understanding of the examples disclosed herein.

Throughout the description and claims, the words “comprise,” “contain” and “include,” and variations thereof, for example “comprising,” “containing” and “including,” means “including but not limited to,” and is not intended to (and does not) exclude other features, elements, components, integers, steps, processes, functions, characteristics, and the like.

Throughout the description and claims, the singular form, for example “a,” “an” and “the,” encompasses the plural unless the context otherwise requires. For example, reference to “an object” includes reference to one or more of such objects.

Throughout the description and claims, language in the general form of “X for Y” (where Y is some action, process, function, activity or step and X is some means for carrying out that action, process, function, activity or step) encompasses means X adapted, configured or arranged specifically, but not necessarily exclusively, to do Y.

Features, elements, components, integers, steps, processes, functions, characteristics, and the like, described in conjunction with a particular aspect, embodiment, example or claim are to be understood to be applicable to any other aspect, embodiment, example or claim disclosed herein unless incompatible therewith.

The following examples are applicable to, and use terminology associated with, 3GPP 5G. However, the skilled person will appreciate that the techniques disclosed herein are not limited to these examples or to 3GPP 5G, and may be applied in any suitable system or standard, for example one or more existing and/or future generation wireless communication systems or standards. The skilled person will appreciate that the techniques disclosed herein may be applied in any existing or future releases of 3GPP 5G NR or any other relevant standard.

For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network. For example, the functionality of an entity in the examples below may be applied to any other suitable type of entity performing functions of a network node.

The skilled person will appreciate that certain examples of the present disclosure may not be directly related to standardization but rather proprietary implementation of some of the sidelink relay adaptation protocol (SRAP) functions or non-SRAP related functions of NR Rel-17 and beyond networks.

The skilled person will appreciate that the present disclosure is not limited to the specific examples disclosed herein. For example:
The techniques disclosed herein are not limited to 3GPP 5G;
The techniques disclosed herein are not limited to SRAP or particular relay networks;
One or more entities in the examples disclosed herein may be replaced with one or more alternative entities performing equivalent or corresponding functions, processes or operations;
One or more of the messages in the examples disclosed herein may be replaced with one or more alternative messages, signals or other type of information carriers that communicate equivalent or corresponding information;
One or more further elements, entities and/or messages may be added to the examples disclosed herein;
One or more non-essential elements, entities and/or messages may be omitted in certain examples;
The functions, processes or operations of a particular entity in one example may be divided between two or more separate entities in an alternative example;
The functions, processes or operations of two or more separate entities in one example may be performed by a single entity in an alternative example;
Information carried by a particular message in one example may be carried by two or more separate messages in an alternative example;
Information carried by two or more separate messages in one example may be carried by a single message in an alternative example;
The order in which operations are performed may be modified, if possible, in alternative examples; and/or
The transmission of information between network entities is not limited to the specific form, type and/or order of messages described in relation to the examples disclosed herein.

Certain examples of the present disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the present disclosure may be provided in the form of a system (e.g., a network) comprising one or more such apparatuses/devices/network entities, and/or a method therefor. For example, in the following examples, a network may include one or more nodes.

It will be appreciated that examples of the present disclosure may be realized in the form of hardware, software or a combination of hardware and software. Certain examples of the present disclosure may provide a computer program comprising instructions or code which, when executed, implement a method, system and/or apparatus in accordance with any aspect, claim, example and/or embodiment disclosed herein. Certain embodiments of the present disclosure provide a machine-readable storage storing such a program.

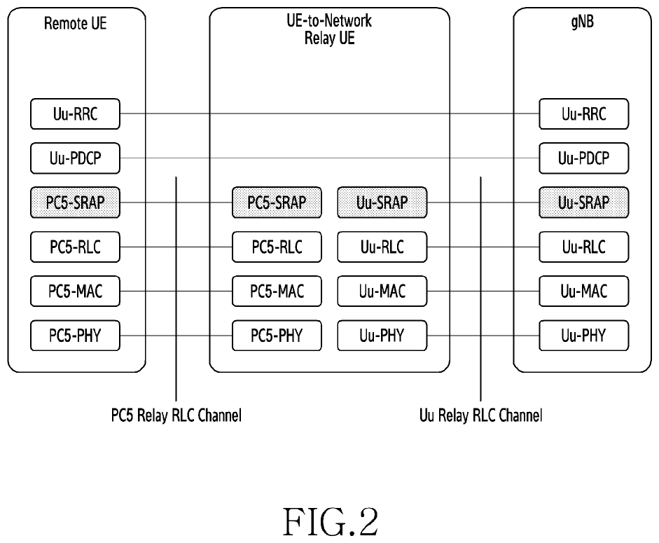

FIG. 1 and FIG. 2 illustrate an example user plane protocol stack and control plane protocol stack for layer 2 (L2) UE-to-NW relay according to embodiments of the present disclosure.

FIG. 1 and FIG. 2 respectively show user and control plane protocol stacks for layer 2 (L2) user equipment (UE)-to-network (NW) relay, as captured in the 3GPP technical specification (TS) 38.800. 3GPP agreed to introduce the Adapt layer on the Uu link (link between relay UE and the gNode B (gNB)), as shown in FIG. 1 and FIG. 2 in shaded boxes. Presence of a separate Adapt layer on the sidelink (SL), i.e., PC5 link (between remote UE and relay UE), has also been confirmed by 3GPP radio layer 2 and radio layer 3 working group (RAN2). The main agreed functionality of Adapt is mapping of uplink (UL) PC5 bearers onto Uu bearers, and performing the inverse process on the downlink (DL).

The Adapt layer was renamed sidelink relay adaptation protocol, or SRAP for short. As captured in 3GPP TS 38.351 specification (capturing SRAP), the following is the basic model and operation of SRAP as agreed by 3GPP:

On the UE-to-network (U2N) relay UE, the SRAP sublayer contains one SRAP entity at Uu interface (air interface between terminal and base station/access point) and a separate collocated SRAP entity at the PC5 interface. On the U2N remote UE, the SRAP sublayer contains only one SRAP entity at the PC5 interface.

Each SRAP entity has a transmitting part and a receiving part. Across the PC5 interface, the transmitting part of the SRAP entity at the U2N remote UE has a corresponding receiving part of an SRAP entity at the U2N relay UE, and vice-versa. Across the Uu interface, the transmitting part of the SRAP entity at the U2N relay UE has a corresponding receiving part of an SRAP entity at the gNB, and vice-versa.

At the remote UE, in the uplink (UL) direction the SRAP may determine SRAP UE identity/identification (ID) and BEARER ID and add the SRAP header. At the remote UE, on the downlink (DL), the SRAP may remove the SRAP header and deliver the packet to higher layers.

At the relay UE, on the UL the SRAP may map the packet from a PC5 channel to a Uu channel using the SRAP UE ID and BEARER ID contained in the packet itself, and the mapping configuration provided by the network. At the relay UE, on the DL the SRAP may map the packet from a Uu channel to a PC5 channel using SRAP UE ID and BEARER ID contained in the packet itself, and the mapping configuration provided by the network.

In future/upcoming 3GPP standard specification, multiple paths could be available for concurrent and/or alternate use between a network node (e.g., base station/gNB) and the destination remote UE.

In the present disclosure, there is provided a routing method in a wireless communication system comprising a network, a destination remote UE, and at least one intermediate UE, the method comprising: selecting at least one path of a plurality of paths for communicating data between the network and destination remote UE; wherein at least one of the plurality of paths is an indirect path that includes the intermediate UE; and wherein the at least one intermediate UE comprises at least one of a further remote UE and a relay UE.

The network may comprise a core network and at least one network node such as a base station.

A relay UE may be a UE that provides functionality to support connectivity to the network for remote UE(s).

A remote UE may be a UE that communicates with the network via a path including a relay UE and/or which communicates with the network via a path including another remote UE. A remote UE may aggregate traffic from multiple remote UEs.

The plurality of paths may be used simultaneously (e.g., to transmit the same packet on each of the paths, to transmit control plane data, e.g., radio resource control (RRC) signalling, on one path and user plane data on another path, to transmit higher priority user plane data on one path and lower priority data on another path) or may be switched between (e.g., based on priority levels).

A path may be a direct path between a base station and the destination remote UE.

A path may also be an indirect path involving a relay UE and/or remote UE between a base station and the destination remote UE. The relay UE or remote UE may be referred to as an intermediate node. An indirect path may involve additional intermediate nodes. For example, the additional intermediate nodes may be one or more additional relay UEs, one or more additional remote UEs, or a combination of these. Intermediate nodes may also be referred to as intermediate UEs, local nodes, or local UEs.

For example, multiple paths may exist in any of the following example scenarios:

A destination remote UE can be reached via a direct path from a first base station, and an indirect path via a first relay UE.

A destination remote UE can be reached via a direct path from a first base station, an indirect path via a first relay UE, and an indirect path via the first relay UE and another remote UE.

A destination remote UE can be reached via a direct path from a first base station, and an indirect path via another remote UE.

A destination remote UE can be reached via a direct path from a first base station, and an indirect path from a second base station via a relay UE.

A destination remote UE can be reached via an indirect path from a first base station via a first relay UE, and an indirect path from a second base station via a second relay UE.

A destination remote UE can be reached via an indirect path from a first base station via a first relay UE, and an indirect path from a second base station via the first relay UE.

It will be appreciated that these are merely examples, and that combinations of direct and indirect paths not listed above may be determined.

In an example, the path selection may be performed by the network, for example by a base station/central unit (CU). The network may perform path selection and then configure base stations and/or intermediate nodes appropriately. Path selection may be performed by a base station, and the base station may configure intermediate nodes accordingly. Path selection may also be performed or altered by an intermediate node (for example, by a remote UE). Path selection may be based on factors such as network conditions, congestion indication, radio link failure (RLF) indication, a path status including status of one or more of radio links comprising the path; or any other appropriate factors. Intermediate nodes (e.g., a remote UE) may provide feedback to the base station regarding path selection and/or path selection factors. Path selection at an intermediate node may comprise selecting a complete path between the destination the source, may comprise selecting a partial path between the intermediate node and the destination, and may comprise selecting only the next hope node.

In an example, the method may comprise determining the plurality of paths. Determining the plurality of paths may comprise identifying paths or defining paths. Determining the plurality of paths may comprise defining routing tables or identifying paths based on existing routing tables. Paths may be identified by one or more of: a path ID; destination node address; next hop node address; the combination of destination node address and next hop node address. Paths' identities may be determined by the network (e.g., CU/base station), and may be identified locally by intermediate nodes (e.g., a remote UE) or the destination remote UE. Local identification may improve adaptability, for example in the case of appearance of a new node which is only visible to local nodes.

Path identifications (IDs) may be used to allow identification of paths and differentiation between the paths. For example, the method may further comprise assigning path IDs to the determined paths or selecting the at least one path based on a path ID of the at least one path. In an example, the path ID may be part of the SRAP packet (e.g., part of the header), allowing data packets from a single end-to-end (E2E) bearer to go via different routes. In another example, the path ID is part of a different layer (e.g., packet data conversion protocol (PDCP)), enforcing the same path for all data packets from a single E2E bearer.

Priority levels may be used to assist in selection of paths. For example, selecting the at least one path may comprise selecting the at least one path based on priority levels. In an example, priority levels could always be used. In another example, priority levels could be used only in cases where a main intended path is unavailable (e.g., due to RLF/congestion), to decide which path to use.

In an example, priority levels may be assigned to paths by the network (e.g., CU/base station). If a priority level is not assigned to a path by the network a certain default value may be assumed by the node performing or implementing path selection.

In another example, priority levels could be decided by intermediate nodes (e.g., relay UEs and/or remote UEs). In this case feedback may be provided to the network on priorities assigned and/or paths used.

In an example, the priority level could be the same as medium access control (MAC)/logical channel priority (LCP) logical channel priority (or logical channel group (LCG) that a logical channel is mapped to) for logical channel to which the SRAP packet is mapped. In this case, the priority level is set as the priority of logical channel to communicate through the path (E2E).

If multiple logical channels with different priorities use the path, priority level can be assigned independently.

In another example, priority level could be unrelated to the logical channel priority.

Hop counts may be used to limit the number of hops per path. For example, selecting the at least one path may comprise selecting the at least one path based on a hop count.

In an example, the hop count may be a limit to the number of hops per SRAP packet. The hop count can be decided on the fly by the base station or intermediate nodes (e.g., a remote UE) depending on current link situation and/or certain requirements for packet transmission, for example latency. The hop count can be decided in advance, based on e.g., E2E quality of service (QoS)/delay requirements for the bearer being carried in the packets in question.

The hop count may be part of the packet header and/or part of routing configuration table. This may be particularly useful for the multi-hop case (i.e., a case where there are at least two layers of U2N relay nodes), but is also useful in the single-hop case, in case a remote UE can be reached via a chain of other remote UEs (thereby effectively creating multi-hop through a combination of U2N and UE-to-UE (U2U), or only U2U in a star formation but where the “direct” link between source and destination UEs is unavailable so data goes around the chain).

In another example, the hop count may be an E2E parameter for end-to-end bearers (e.g., traffic flow/QoS flow/radio bearer/logical channel).

Path selection may be performed at least in part based on information in the packet header (e.g., SRAP header) such as destination address, maximum hop count, time stamp, expiry time, QoS requirements.

Path selection may be based on routing tables. Routing tables may include information on links between nodes in the network, for example links between a base station, intermediate nodes (e.g., remote UEs), and the destination remote UE. Nodes may store routing tables comprising information about links between network nodes, and may select a path or next hop node based on the information in the routing table. Routing tables may be configured at nodes (e.g., relay UEs and remote UEs) by the network (e.g., base station/CU).

In existing systems, traffic received by a remote UE terminates at the remote UE. In an example of the present disclosure, routing tables at relay UEs may include links (either direct, or via a relay UE) between remote UEs to enable paths to a destination remote UE via other remote UEs. A relay UE may store a routing table comprising information about links between remote UEs, and may select a path or next hop node at least in part based on the information in the routing table. Routing tables may also be implemented at remote UEs to enable a remote UE to forward traffic to another remote UE. That is, a remote UE may store a routing table comprising information about links between remote UEs, and may select a path or next hop node based on the information in the routing table.

A cost metric may be determined by the network for each path, based on, for example, delay, fairness, or reliability (e.g., probability of correct packet reception). The cost metric may be the cost to a packet/bearer/traffic flow of using a particular path. The delay may be based on the delay per hop, or may be based on the E2E delay, i.e., having different delay per hop depending on overall number of hops, to ensure the same level of service regardless of the number of hops. Fairness may be defined as offering the same service to packets/bearers/traffic flows with same QoS requirement, regardless of the individual paths through the network.

The cost metric may be configured at nodes (e.g., relay UEs and remote UEs) by the network (e.g., base station/CU). For example, the cost metric may be configured by the same signaling used to configure routing tables.

The cost metric may be packet/bearer/flow specific.

The cost metric may be used to assist local node (e.g., remote UE) decision making. For example, selecting the at least one path may comprise selecting the at least one path based on a cost metric of the path. Based on the cost metric, the local node may determine to discard packets. The local node may determine a delay or reliability based on, for example, content of the packet (e.g., packet header); content of the routing table linked to a specific SRAP ID/bearer ID/flow ID; and/or direct signalling from the network. For example, the cost metric may define a maximum tolerable delay, and packets determined to exceed the delay may be discarded by the local node. This supports discarding at intermediate nodes (e.g., a remote UE) of packets no longer “useful,” or packets less likely to meet their QoS requirement in case where there is possibility of buffer overflow.

A user packet may be transmitted using multiple paths, for example Uu (direct) and U2N relay (indirect). In this case, for example, either the base station or the destination remote UE may inform the relay UE to discard a buffered adapt/SRAP layer packet at relay when the user packet is received via Uu direct. That is, when a packet is received at the first gNB or the destination remote UE via a direct path (or a faster indirect path), one or more intermediate nodes (e.g., a remote UE) in the (slower) indirect path may be informed by the base station or the destination remote UE to discard the packet. This may reduce unnecessary signalling and resource usage when using multiple paths.

Packets may be discarded by the intermediate nodes (e.g., a remote UE) when it is clear they cannot be delivered while keeping the required QoS. In this case, the packets are not delivered and feedback to the originating node may be provided for purposes of retransmission/stopping or starting a delivery timer/modifying a counter of dropped packets or correctly received ones, etc.

In existing systems, a remote UE either originates or terminates traffic. In examples of the present disclosure, remote UEs are able to act as intermediate nodes by forwarding traffic to other remote UEs (for example the destination remote UE) or relay UEs. That is, a remote UE in a wireless communication system may receive data from a first UE (e.g., relay UE or remote UE) and forward the data to a second UE (e.g., relay UE or remote UE). Some examples (where appropriate) may function without gNB involvement e.g., remote UE and a further remote UE and/or a relay UE communicating between each other and transparently to gNB. This means a remote UE may assign the path IDs etc. and then select paths (e.g., based on pre-configured conditions, path ID, a priority level, hop count, path status, routing table, cost metric, etc.). The remote UE may also assign SRAP IDs to itself and/or other remote UEs.

Signals may be exchanged between the network nodes to support coordination. For example, the following signal exchanges may take place:
Serving gNB to target gNB: L2 relay UE configuration/L2 remote UE configuration (e.g., SL communication parameters, SRAP configuration which may include routing table, Path IDs, priority levels, maximum hop counts, cost metrics, and SRAP IDs);
Serving gNB to remote UE/relay UE: L2 remote UE configuration/L2 relay UE configuration (SRAP configuration);
Target gNB to Serving gNB: refusal of path switching and/or providing level of availability (e.g., existing/expected load) and/or suggested L2 relay UE configuration/L2 remote UE configuration; and/or
Target gNB to remote UE/relay UE: L2/SRAP reconfiguration.

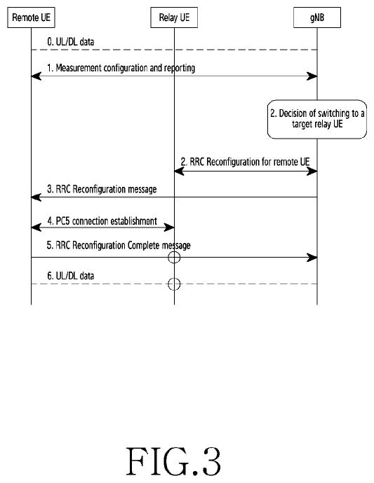

FIG. 3 illustrates steps in routing method in a network comprising a base station (gNB), a remote UE, and a relay UE according to an embodiment of the present disclosure.

FIG. 3 illustrates steps in routing method in a network comprising a base station (gNB), a remote UE, and a relay UE. In an example, the method may be based on the method described in TS 38.300.

At step 0, UL and DL data is exchanged between the gNB and the remote UE based on a current path. For example, the data may be transmitted and received via a direct path between the gNB and the remote UE. It will be appreciated that this step may not be present, and that the method may begin at step 1.

At step 1, measurement configuration and reporting takes place between the gNB and the remote UE.

For example, the L2 U2N remote UE may report one or multiple candidate L2 U2N relay UE(s) and Uu measurements, after the remote UE measures/discovers the candidate L2 U2N relay UE(s):
The L2 U2N remote UE may filter the appropriate L2 U2N relay UE(s) according to relay selection criteria before reporting. The L2 U2N remote UE may report only the L2 U2N relay UE candidate(s) that fulfil the higher layer criteria; and
The reporting may include at least L2 U2N relay UE ID, L2 U2N relay UE's serving cell ID, and sidelink measurement quantity information. The sidelink measurement quantity can be sidelink reference signal received power (SL-RSRP) of the candidate L2 U2N relay UE, and if SL-RSRP is not available, sidelink discovery reference signal received power (SD-RSRP) may be used.

At step 2, the gNB determines to switch to an indirect path via a target relay UE. That is, the gNB may perform path selection as described above. The determination to switch, and the selection of the indirect path or target relay UE, may be based on the measurement configuration and reporting performed in step 1 (e.g., network conditions, congestion indication, RLF indication, path status including status of one or more of radio links comprising the path) and may alternatively or additionally be based on one or more of a path ID, a priority level, a hop count, a routing table, and a cost metric. Then RRC reconfiguration for the remote UE is performed.

For example, the gNB may decide to switch the L2 U2N remote UE to a target L2 U2N relay UE. Then the gNB may send an RRCReconfiguration message to the target L2 U2N relay UE, which may include at least L2 U2N remote UE's local ID and L2 ID, Uu and PC5 relay radio link control (RLC) channel configuration for relaying, and bearer mapping configuration.

At step 3, the gNB transmits an RRC reconfiguration message to the remote UE.

For example, the gNB may send the RRCReconfiguration message to the L2 U2N remote UE. The RRCReconfiguration message may include at least L2 U2N relay UE ID, remote UE's local ID, PC5 relay RLC channel configuration for relay traffic and the associated end-to-end radio bearer(s). The L2 U2N remote UE may stop user plane (UP) and control plane (CP) transmission over Uu after reception of RRCReconfiguration message from the gNB.

At step 4, PC5 (i.e., sidelink) connection is established between the remote UE and the relay UE.

For example, the L2 U2N remote UE may establish PC5 RRC connection with target L2 U2N relay UE.

At step 5, the remote UE transmits an RRC reconfiguration complete message to the gNB via the relay UE.

For example, the L2 U2N remote UE may complete the path switch procedure by sending the RRCReconfigurationComplete message to the gNB via the L2 U2N relay UE.

At step 6, UL and DL data is exchanged between the gNB and remote UE via the relay UE. For example, the data may be transmitted and received via an indirect path between the gNB and the remote UE, the indirect path including the relay UE.

For example, the data path may be switched from direct path to indirect path between the L2 U2N remote UE and the gNB.

For a remote UE's configuration at target gNB, the configuration may be transferred through RRCReconfiguration (i.e., step 3 in FIG. 3) with path switch command from a serving gNB to remote UE, as in TS 38.300 v17.0.0, for example. The parameters may be the same as in the existing intra gNB path switch command and may additionally or alternatively include one or more of the configuration parameters set out above, such as routing tables, path IDs, priority levels, maximum hop counts, cost metrics, etc. For the relay UE's configuration at target gNB, the configuration may be transferred through RRCReconfiguration (i.e., step 2 in FIG. 3) by target gNB to relay UE. The parameters may be the same as in the existing intra gNB path switch and may additionally or alternatively include one or more of the configuration parameters set out above, such as routing tables, path IDs, priority levels, maximum hop counts, cost metrics, etc.

It will be appreciated that a routing method similar to the above steps for switching from a direct path to an indirect path may also be applied to the case of switching a first indirect path via a first relay UE to a second indirect path via a second relay UE. In this case, the relay configuration of the second relay UE (e.g., the RRC(Re)configuration message) may include additional signalling information such as relay configuration. For example, the steps may be as follows:

At step 0, UL and DL data is exchanged between the gNB and the remote UE based on a first indirect path via a first relay UE.

At step 1, measurement configuration and reporting takes place between the gNB and the first relay UE. In an example, measurement configuration and reporting may also take place between the gNB and a second relay UE.

At step 2, the gNB determines to switch to a second indirect path via a (target) second relay UE. That is, the gNB may perform path selection as described above. The determination to switch, and the selection of the indirect path or second relay UE, may be based on the measurement configuration and reporting performed in step 1 (e.g., network conditions, congestion indication, RLF indication, path status including status of one or more of radio links comprising the path) and may alternatively or additionally be based on one or more of a path ID, a priority level, a hop count, a routing table, and a cost metric. Then RRC reconfiguration for the second relay UE is performed between the second relay UE and the gNB. In an example, the gNB may communicate with the first relay UE to inform the first relay UE of the path switch, update routing tables (for example to remove UEs no longer accessing the network via the first relay UE), configure operation parameters, etc.

The parameters for the second relay UE configuration may be transferred through RRC reconfiguration and may be the same as in the existing intra gNB path switch and may additionally or alternatively include one or more of the configuration parameters set out above, such as routing tables, path IDs, priority levels, maximum hop counts, cost metrics, etc.

The parameters for the remote UE configuration may be transferred through RRC reconfiguration and may be the same as in the existing intra gNB path switch command and may additionally or alternatively include one or more of the configuration parameters set out above, such as routing tables, path IDs, priority levels, maximum hop counts, cost metrics, etc.

At step 3, the gNB transmits an RRC reconfiguration message to the remote UE.

At step 4, PC5 (i.e., sidelink) connection is established between the remote UE and the second relay UE.

At step 5, the remote UE transmits an RRC reconfiguration complete message to the gNB via the second relay UE.

At step 6, UL and DL data is exchanged between the gNB and remote UE via the second relay UE. For example, the data may be transmitted and received via the second indirect path between the gNB and the remote UE, the indirect path including the second relay UE.

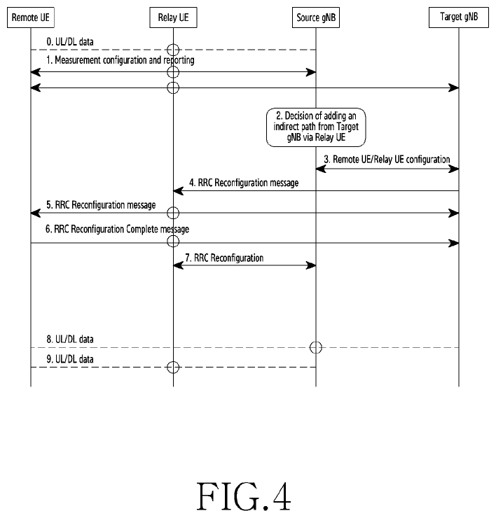

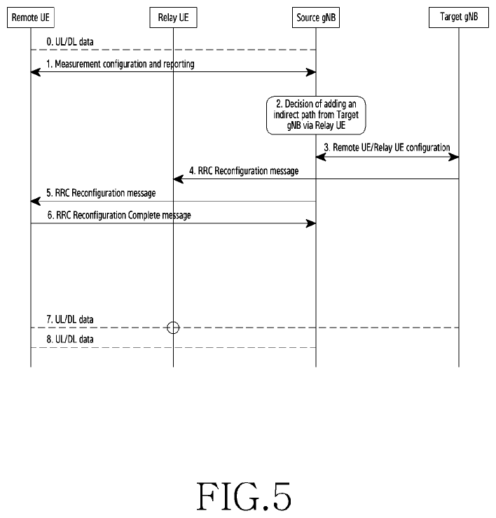

FIGS. 4 and 5 illustrate steps in routing methods in systems comprising source and target base stations (gNBs), a remote UE, and a relay UE.

When multi-path involves non-intra gNB cases, then simultaneous multiple paths can be configured similar to dual connectivity, which is different from path switch (handover). In non-intra gNB case, a different message or different information element (IE) is used for relay multi-path in standards than in the case of path switch command. As an example, remote UE's configuration at target gNB or relay UE's configuration at target gNB can be transferred through RRCReconfiguration message used to configure SCG (secondary cell group configuration), where the parameters are same as in intra gNB path switch command (i.e., step 3 in FIG. 3) and the parameters are same as in intra gNB path switch (i.e., step 2 in FIG. 3), respectively.

FIG. 4 illustrates steps in routing method in a system comprising source and target base stations (gNBs), a remote UE, and a relay UE.

FIG. 4 illustrates establishment of an indirect path in addition to an existing indirect path in a non-intra gNB case. Although FIG. 4 illustrates addition of an indirect path via the same (first) relay UE as between the target gNB and the remote UE, it will be appreciated that the additional indirect path may pass via a different (second) relay UE:

At step 0, UL and DL data is exchanged between the source gNB and the remote UE based on an indirect path via the relay UE.

At step 1, measurement configuration and reporting takes place between the source gNB and the remote UE via the relay UE, and optionally between the target gNB and the remote UE via the relay UE. The measurement configuration and reporting in each case may be the same as for step 1 of FIG. 3. Although FIG. 4 illustrates measurement configuration and reporting taking place between the source gNB and the remote UE via the same (first) relay UE as between the target gNB and the remote UE, it will be appreciated that the measurement configuration and reporting taking place between the target gNB and the remote UE may take place via a different (second) relay UE.

At step 2, a decision is made by the network or the source gNB to add an indirect path from the target gNB to the remote UE via the relay UE. The additional indirect path may use the first (i.e., same) relay UE or may use a second (i.e., different) relay UE. The source gNB may perform path selection as described above. The determination to add the indirect path may be based on the measurement configuration and reporting performed in step 1 (e.g., network conditions, congestion indication, RLF indication, path status including status of one or more of radio links comprising the path) and may alternatively or additionally be based on one or more of a path ID, a priority level, a hop count, a routing table, and a cost metric.

At step 3, the remote UE configuration and/or relay UE configuration may be transferred from the source gNB to the target gNB. The parameters for the relay UE configuration may be transferred through an SCG-configuration-like procedure. The parameters may be the same as in the existing intra gNB path switch and may additionally or alternatively include one or more of the configuration parameters set out above, such as routing tables, path IDs, priority levels, maximum hop counts, cost metrics, etc.

The parameters for the remote UE configuration may be transferred through an SCG-configuration-like procedure. The parameters may be the same as in the existing intra gNB path switch command and may additionally or alternatively include one or more of the configuration parameters set out above, such as routing tables, path IDs, priority levels, maximum hop counts, cost metrics, etc.

At step 4, the target gNB performs RRC reconfiguration. Step 4 may comprise transmitting an RRC reconfiguration message including the relay UE configuration to the (first or second) relay UE.

At step 5, the target gNB transmits an RRC reconfiguration message including the remote UE configuration to the remote UE via the (first or second) relay UE.

At step 6, the remote UE transmits an RRC reconfiguration complete message to the target gNB via the (first or second) relay UE.

In some examples, steps 5 and 6 may alternatively take place between the source gNB and the remote UE instead of the target gNB and remote UE.

At step 7, RRC reconfiguration optionally takes place between the first relay UE and source gNB. The RRC reconfiguration may include updated relay UE configuration due to the additional indirect path. The relay UE configuration may be updated at least in part according to the configuration in step 3.

At step 8, UL and DL data is exchanged between the target gNB and remote UE via the (first or second) relay UE.

At step 9, UL and DL data continues to be exchanged between the source gNB and remote UE via the (first) relay UE. An additional indirect path via the (same or different) relay UE has been established between the target gNB and remote UE in addition to the existing indirect path via the relay UE between the source gNB and remote UE.

FIG. 5 illustrates steps in routing method in a system comprising source and target base stations (gNBs), a remote UE, and a relay UE according to an embodiment of the present disclosure.

FIG. 5 illustrates establishment of an indirect path in addition to an existing direct path in a non-intra gNB case:

At step 0, UL and DL data is exchanged between the source gNB and the remote UE based on a direct path.

At step 1, measurement configuration and reporting takes place between the source gNB and the remote UE. The measurement configuration and reporting in each case may be the same as for step 1 of FIG. 3.

At step 2, the source gNB decides to add an indirect path from the target gNB to the remote UE via the relay UE. The source gNB may perform path selection as described above. The determination to add the indirect path may be based on the measurement configuration and reporting performed in step 1 (e.g., network conditions, congestion indication, RLF indication, path status including status of one or more of radio links comprising the path) and may alternatively or additionally be based on one or more of a path ID, a priority level, a hop count, a routing table, and a cost metric.

At step 3, the remote UE configuration and/or relay UE configuration may be transferred from the source gNB to the target gNB. The parameters for the relay UE configuration may be transferred through an SCG-configuration-like procedure. The parameters may be the same as in the existing intra gNB path switch and may additionally or alternatively include one or more of the configuration parameters set out above, such as routing tables, path IDs, priority levels, maximum hop counts, cost metrics, etc.

The parameters for the remote UE configuration may be transferred through an SCG-configuration-like procedure and may be the same as in the existing intra gNB path switch command and may additionally or alternatively include one or more of the configuration parameters set out above, such as routing tables, path IDs, priority levels, maximum hop counts, cost metrics, etc.

At step 4, the target gNB performs RRC reconfiguration. Step 4 may comprise transmitting an RRC reconfiguration message including the relay UE configuration to the relay UE.

At step 5, the source gNB transmits an RRC reconfiguration message including the remote UE configuration to the remote UE.

At step 6, the remote UE transmits an RRC reconfiguration complete message to the source gNB.

At step 7, UL and DL data is exchanged between the target gNB and remote UE via the relay UE.

At step 8, UL and DL data continues to be exchanged between the source gNB and remote UE. An indirect path via the relay UE has been established between the target gNB and remote UE in addition to the existing direct path between the source gNB and remote UE.

Certain examples of the present disclosure provide a first entity (e.g., a core network, a base station, a relay UE, a remote UE) configured to operate according to a method according to any example, embodiment, aspect and/or claim disclosed herein.

Certain examples of the present disclosure provide a second entity (e.g., a core network, a base station, a relay UE, a remote UE) configured to cooperate with a first network entity of the preceding example according to any example, embodiment, aspect and/or claim disclosed herein.

Certain examples of the present disclosure provide a network or wireless communication system comprising a first entity and a second entity according to any example, embodiment, aspect and/or claim disclosed herein.

Certain examples of the present disclosure provide a computer program comprising instructions which, when the program is executed by a computer or processor, cause the computer or processor to carry out a method according to any example, embodiment, aspect and/or claim disclosed herein.

Certain examples of the present disclosure provide a computer or processor-readable data carrier having stored thereon a computer program according to the preceding examples.

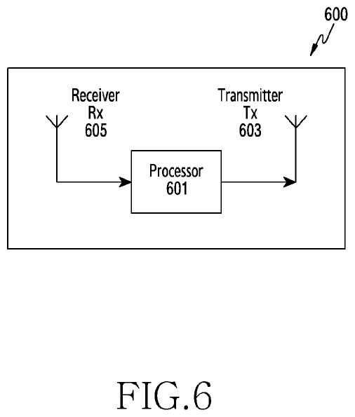

FIG. 6 illustrates an exemplary entity (e.g., a core network entity, a base station, a relay UE, a remote UE) according to an embodiment of the present disclosure. The skilled person will appreciate that the entity illustrated in FIG. 6 may be implemented, for example, as a network element on a dedicated hardware, as a software instance running on a dedicated hardware, or as a virtualised function instantiated on an appropriate platform, e.g., on a cloud infrastructure.

The entity 600 comprises a processor (or controller) 601, a transmitter 603, and a receiver 605. The receiver 605 is configured for receiving one or more messages from one or more other network entities. The transmitter 603 is configured for transmitting one or more messages to one or more other network entities. The processor 601 is configured for performing operations as described above.

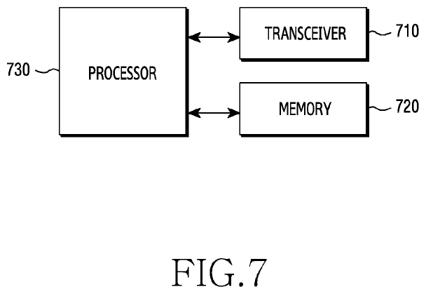

FIG. 7 illustrates a structure of a UE according to an embodiment of the present disclosure.

As shown in FIG. 7, the UE according to an embodiment may include a transceiver 710, a memory 720, and a processor 730. The transceiver 710, the memory 720, and the processor 730 of the UE may operate according to a communication method of the UE described above. However, the components of the UE are not limited thereto. For example, the UE may include more or fewer components than those described above. In addition, the processor 730, the transceiver 710, and the memory 720 may be implemented as a single chip. Also, the processor 730 may include at least one processor.

The transceiver 710 collectively refers to a UE receiver and a UE transmitter, and may transmit/receive a signal to/from a base station or a network entity. The signal transmitted or received to or from the base station or a network entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the UE. Also, the memory 720 may store control information or data included in a signal obtained by the UE. The memory 720 may be a storage medium, such as read-only memory (ROM), random access memory (RAM), a hard disk, a CD-ROM, and a DVD, or a combination of storage media.

The processor 730 may control a series of processes such that the UE operates as described above. For example, the transceiver 710 may receive a data signal including a control signal transmitted by the base station or the network entity, and the processor 730 may determine a result of receiving the control signal and the data signal transmitted by the base station or the network entity.

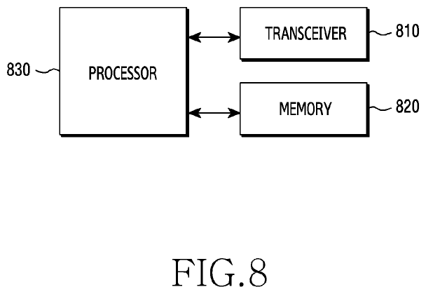

FIG. 8 illustrates a structure of a base station according to an embodiment of the present disclosure.

As shown in FIG. 8, the base station according to an embodiment may include a transceiver 810, a memory 820, and a processor 830. The transceiver 810, the memory 820, and the processor 830 of the base station may operate according to a communication method of the base station described above. However, the components of the base station are not limited thereto. For example, the base station may include more or fewer components than those described above. In addition, the processor 830, the transceiver 810, and the memory 820 may be implemented as a single chip. Also, the processor 830 may include at least one processor.

The transceiver 810 collectively refers to a base station receiver and a base station transmitter, and may transmit/receive a signal to/from a terminal. The signal transmitted or received to or from the terminal may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the base station. Also, the memory 820 may store control information or data included in a signal obtained by the base station. The memory 820 may be a storage medium, such as read-only memory (ROM), random access memory (RAM), a hard disk, a CD-ROM, and a DVD, or a combination of storage media.

The processor 830 may control a series of processes such that the base station operates as described above. For example, the transceiver 810 may receive a data signal including a control signal transmitted by the terminal, and the processor 830 may determine a result of receiving the control signal and the data signal transmitted by the terminal.

In one example, a routing method is provided in a wireless communication system comprising a network, a destination remote UE, and at least one intermediate UE, the method comprising: selecting at least one path of a plurality of paths for communicating data between the network and destination remote UE; wherein at least one of the plurality of paths is an indirect path that includes the at least one intermediate UE; and wherein the at least one intermediate UE comprises at least one of a further remote UE and a relay UE.

In another example, a routing method of a base station is provided, the method comprising: selecting at least one path of a plurality of paths for communicating data between a network and a destination remote UE via the base station; wherein at least one of the plurality of paths is an indirect path that includes at least one intermediate UE; and wherein the at least one intermediate UE comprises at least one of a further remote UE and a relay UE.

In yet another example, a routing method of a relay UE is provided, the method comprising: selecting at least one path of a plurality of paths for communicating data between a network and destination remote UE via the relay UE.

In yet another example, a routing method of a remote UE is provided, the method comprising: selecting at least one path of a plurality of paths for communicating data between a network and the remote UE; wherein at least one of the plurality of paths is an indirect path that includes at least one intermediate UE; and wherein the at least one intermediate UE comprises at least one of a further remote UE and a relay UE.

In yet another example, the method of any of the first to fourth examples is provided, wherein at least one of the plurality of paths is an indirect path that includes the further remote UE or relay UE and further includes an additional intermediate UE.

In yet another example, the method of the fifth example is provided, wherein the additional intermediate UE is an additional remote UE.

In yet another example, a routing method of a first remote UE is provided, the method comprising: selecting at least one path of a plurality of paths for communicating data between a network and a destination remote UE via at least one of a further remote UE and a relay UE.

In yet another example, a wireless communication system comprising a network, a destination remote UE, and at least one intermediate UE is provided, wherein the system is configured to: select at least one path of a plurality of paths for communicating data between the network and destination remote UE; wherein at least one of the plurality of paths is an indirect path that includes the at least one intermediate UE; and wherein the at least one intermediate UE comprises at least one of a further remote UE and a relay UE.

In yet another example, a base station is provided, wherein the base station is configured to: select at least one path of a plurality of paths for communicating data between a network and a destination remote UE via the base station; wherein at least one of the plurality of paths is an indirect path that includes at least one intermediate UE; and wherein the at least one intermediate UE comprises at least one of a further remote UE and a relay UE.

In yet another example, a relay UE is provided, the relay UE configured to: select at least one path of a plurality of paths for communicating data between a network and destination remote UE via the relay UE.

In yet another example, a remote UE is provided, the remote UE configured to: select at least one path of a plurality of paths for communicating data between a network and the remote UE; wherein at least one of the plurality of paths is an indirect path that includes at least one intermediate UE; and wherein the at least one intermediate UE comprises at least one of a further remote UE and a relay UE.

In yet another example, the apparatus of any of the eighth to eleventh examples is provided, wherein at least one of the plurality of paths is an indirect path that includes the further remote UE or relay UE and further includes an additional intermediate UE.

In yet another example, the apparatus of the twelfth example is provided, wherein the additional intermediate UE is an additional remote UE.

In yet another example, a first remote UE is provided, the first remote UE configured to: select at least one path of a plurality of paths for communicating data between a network and a destination remote UE via at least one of a further remote UE and a relay UE.

In yet another example, the method, apparatus, or system of any of the first to fourteenth examples is provided, wherein selecting at least one path of a plurality of paths comprises selecting the at least one path based on one or more of: a path ID; a priority level; a hop count; a path status including status of one or more of radio links comprising the path; selecting individual hops that comprise the path, the selection being done by one or more nodes; a routing table; and a cost metric.

In yet another example, the method, apparatus, or system of any of the first to fifteenth examples is provided, wherein selecting at least one path of a plurality of paths comprises selecting a plurality of paths.

In yet another example, a method of a remote UE in a wireless communication system is provided, the method comprising: receiving data from a first UE; and forwarding the data to a second UE; wherein each of the first UE and second UE comprises a remote UE or a relay UE.

In yet another example, the method of the seventeenth example is provided, the method further comprising assigning a path ID to the path comprising the remote UE and the second UE.

In yet another example, the method of the seventeenth or eighteenth example is provided, the method further comprising assigning a SRAP ID to the remote UE.

In yet another example, the method of the nineteenth example is provided, the method further comprising assigning a SRAP ID to at least one of the first UE and second UE.

In yet another example, the method of any of the seventeenth to twentieth examples is provided, wherein forwarding the data to the second UE comprises selecting a path comprising the second UE based on one or more of one or more of: a path ID; a priority level; a hop count; a path status including status of one or more of radio links comprising the path; a routing table; and a cost metric.

In yet another example, a remote UE is provided, the remote UE configured to perform the method of any of the seventeenth to twenty-first examples.

While the disclosure has been shown and described with reference to certain examples, it will be understood by those skilled in the art that various changes in form and detail may be made therein without departing from the scope of the disclosure, as defined by the appended claims.

Certain examples of the present disclosure provide one or more techniques as disclosed in the appended annex to the description. The skilled person will appreciate that any of these techniques may be applied in combination with any of the techniques described above and illustrated in the Figures.

It should be understood that the terms “first,” “second,” “third,” “fourth,” “1,” “2,” etc. (if present) in the specification and claims of this disclosure and the accompanying drawings above are used to distinguish similar objects and need not be used to describe a particular order or sequence. It should be understood that the data so used is interchangeable where appropriate so that embodiments of the present disclosure described herein can be implemented in an order other than that illustrated or described in the text.

It should be understood that while the flow diagrams of embodiments of the present disclosure indicate the individual operational steps by arrows, the order in which these steps are performed is not limited to the order indicated by the arrows. Unless explicitly stated herein, in some implementation scenarios of embodiments of the present disclosure, the implementation steps in the respective flowcharts may be performed in other orders as desired. In addition, some or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the present disclosure are not limited thereto.

The above-mentioned description is merely an alternative embodiment for some implementation scenarios of the present disclosure, and it should be noted that it would have been within the scope of protection of embodiments of the present disclosure for those skilled in the art to adopt other similar implementation means based on the technical idea of the present disclosure without departing from the technical concept of the solution of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A base station (BS) in a wireless communication system, the BS comprising:
a transceiver; and
a controller coupled with the transceiver, and configured to:
receive, from a first user equipment (UE) which is a remote UE via a direct path between the first UE and the BS, information on one or more radio links associated with the direct path and an indirect path between the first UE and the BS,
transmit, to the first UE, information for a path switching from the direct path to the indirect path, and
communicate with the first UE via the indirect path.

2. The BS of claim 1, wherein the indirect path comprises one of a layer-2 UE-to-network relay UE or a second UE which is another remote UE.

3. The BS of claim 1, wherein data traffic received from the remote UE via the indirect path is aggregated with data traffic from multiple remote UEs.

4. The BS of claim 1, wherein the information on the one or more radio links includes at least one of a network condition, a congestion indication, or a radio link failure (RLF) indication.

5. A first user equipment (UE) which is a remote UE in a wireless communication system, the first UE comprising:
a transceiver; and
a controller coupled with the transceiver, and configured to:
transmit, to a base station (BS) via a direct path between the first UE and the BS, information on one or more radio links associated with the direct path and an indirect path between the first UE and the BS,
receive, from the BS, information for a path switching from the direct path to the indirect path, and
communicate with the BS via the indirect path.

6. The UE of claim 5, wherein the indirect path comprises one of a layer-2 UE-to-network relay UE or a second UE which is another remote UE.

7. The UE of claim 5, wherein data traffic transmitted via the indirect path is aggregated with data traffic from multiple remote UEs.

8. The UE of claim 5, wherein the information on the one or more radio links includes at least one of a network condition, a congestion indication, or a radio link failure (RLF) indication.

9. A method performed by a base station (BS) in a wireless communication system, the method comprising:
receiving, from a first user equipment (UE) which is a remote UE via a direct path between the first UE and the BS, information on one or more radio links associated with the direct path and an indirect path between the first UE and the BS;
transmitting, to the first UE, information for a path switching from the direct path to the indirect path; and
communicating with the first UE via the indirect path.

10. The method of claim 9, wherein the indirect path comprises one of a layer-2 UE-to-network relay UE or a second UE which is another remote UE.

11. The method of claim 9, wherein data traffic received from the remote UE via the indirect path is aggregated with data traffic from multiple UEs.

12. The method of claim 9, wherein the information on the one or more radio links includes at least one of a network condition, a congestion indication, or a radio link failure (RLF) indication.

13. A method performed by a first user equipment (UE) which is a remote UE in a wireless communication system, the method comprising:
transmitting, to a base station (BS) via a direct path between the first UE and the BS, information on one or more radio links associated with the direct path and an indirect path between the first UE and the BS;
receiving, from the BS, information for a path switching from the direct path to the indirect path; and
communicating with the BS via the indirect path.

14. The method of claim 13, wherein the indirect path comprises one of a layer-2 UE-to-network relay UE or a second UN which is another remote UE.

15. The method of claim 13, wherein data traffic transmitted via the indirect path is aggregated with data traffic from multiple remote UEs.

16. The method of claim 13, wherein the information on the one or more radio links includes at least one of a network condition, a congestion indication, or a radio link failure (RLF) indication.
